(19) United States
(12) Patent Application Publication
(10) Pub. No.: US 2026/0128987 A1
(43) Pub. Date: May 7, 2026

(54) Generalized Edge Compute (GEC) architecture with egress link safety

(71) Applicant: Akamai Technologies, Inc., Cambridge, MA (US)

(72) Inventors: Utkarsh Goel, Playa Del Rey, CA (US); Igor B. Lubashev, Arlington, MA (US); Anna R. Blasiak, Somerville, MA (US); Kevin P. Fuerst, Somerville, MA (US)

(21) Appl. No.: 18/926,732

(22) Filed: Oct. 25, 2024

(51) Int. Cl. H04L 47/12; G06F 9/455; H04L 43/0876; H04L 47/263

(52) U.S. Cl. CPC H04L 47/12; G06F 9/45558; H04L 43/0876; H04L 47/263; G06F 2009/45595

(57) ABSTRACT

A Generalized Edge Compute (GEC) architecture that enables customers to deploy their applications in a VM environment hosted on overlay network hardware and software, thereby leveraging all of the advantages provided by a widely-distributed overlay. The architecture also includes a link safety mechanism to ensure that GEC traffic does not over-consume link resources associated with an edge host.

### BACKGROUND OF THE INVENTION

Distributed computer systems are well-known in the prior art. One such distributed computer system is a “content delivery network” (CDN) or “overlay network” that is operated and managed by a service provider. The service provider typically provides the content delivery service on behalf of third parties (customers) who use the service provider's shared infrastructure. A distributed system of this type typically refers to a collection of autonomous computers linked by a network or networks, together with the software, systems, protocols and techniques designed to facilitate various services, such as content delivery, web application acceleration, or other support of outsourced origin site infrastructure. A CDN service provider typically provides service delivery through digital properties (such as a website), which are provisioned in a customer portal and then deployed to the network.

Cloud computing is an information technology delivery model by which shared resources, software and information are provided on-demand over a network (e.g., the publicly-routed Internet) to computers and other devices. This type of delivery model has significant advantages in that it reduces information technology costs and complexities, while at the same time improving workload optimization and service delivery. In a typical use case, an application is hosted from network-based resources and is accessible through a conventional browser or mobile application. Cloud compute resources typically are deployed and supported in data centers that run one or more network applications, typically using a virtualized architecture wherein applications run inside virtual servers, or virtual machines (VMs), which are mapped onto physical servers in the data center. The virtual machines typically run on top of a hypervisor, which allocates physical resources to the virtual machines.

Traditional cloud providers typically support VMs and containers in a relatively small number of core data centers. Recently, the notion of “generalized edge compute” (GEC) has been proposed, wherein the capabilities of a multi-tenant cloud compute infrastructure are extended to edge Points of Presence (PoPs) of an overlay such as a CDN. By enabling full stack computing power to be brought to hundreds of previously hard to reach locations, deploying a cloud compute infrastructure control plane on overlay network edge machines would provide significant advantages. Indeed, deploying compute into an edge platform would also take advantage of existing overlay network operational tools, processes, and observability-enabling developers to innovate across the entire continuum of compute, providing a consistent experience from centralized cloud to distributed edge.

While a GEC solution such as described could provide significant advantages—by enabling customers to deploy applications in a VM environment hosted in CDN edge hardware—the potential integration of these solutions raises traffic management concerns. In particular, a GEC solution would allow customers to host bandwidth-intensive applications, generate web-like traffic, mix both traffic patterns, or bring new traffic profiles, all without prior knowledge or approval of the CDN provider that is responsible for managing traffic delivered from its edge infrastructure. Indeed, customers on the GEC network are expected to run any type of workload at any time, to use their own load balancers (for a typical multi-tenant compute implementation), and to do so without knowledge or visibility about the CDN's own traffic demands and available link capacities. This has the potential to cause congestion on the overlay network, thereby potentially impacting CDN and other services running on the platform, and to overload links, potentially leaving minimal bandwidth for other overlay network services.

### SUMMARY OF THE INVENTION

A cloud compute infrastructure control plane is deployed on overlay network edge machines. As noted above, this generalized edge compute (GEC) solution combines the computing power of the cloud compute infrastructure with the proximity and efficiency of the edge to put workloads closer to users. According to this disclosure, this generalized edge compute architecture is enhanced with a link safety mechanism configured to limit egress traffic for customers, especially high-bandwidth customers. In non-saturation scenarios, the GEC network is allowed to use as much capacity as it needs, while leaving bandwidth for other services and preventing congestion on the link. When, however, a link is determined to be approaching saturation, the link safety mechanism is engaged. In one embodiment, and as a consequence, GEC traffic on the link is reduced to a configurable amount of link capacity. The GEC network may be configured in association with a single edge machine region, or in a set of such regions and their associated network infrastructure (e.g., within a metropolitan area or “metro”) that shares connectivity to the Internet; in the latter case, the GEC traffic management is further controlled according to the dynamic conditions in the metro network. Further, and according to the link safety methods herein, bandwidth allocation among VMs preferably is maximized in favor of VMs that need the most bandwidth at the time of any throttling action while allocating a share proportional to a VM “plan size” (e.g., in terms of vCPU count) in the case of bandwidth scarcity. Further, preferably only VMs exceeding their bandwidth share are then rate-limited if necessary to ensure the link safety.

The foregoing has outlined some of the more pertinent features of the disclosed subject matter. These features should be construed to be merely illustrative. Many other beneficial results can be attained by applying the disclosed subject matter in a different manner or by modifying the subject matter as will be described.

### BRIEF DESCRIPTION OF DRAWINGS

FIG. 1 depicts an overlay network configured as a content delivery network (CDN);

FIG. 2 depicts a representative edge machine in the overlay network;

FIG. 3 depicts a representative virtual machine (VM) operating environment within a data center;

FIG. 4 depicts a representative cloud compute site;

FIG. 5 depicts a control plane for managing the cloud compute site in FIG. 3;

FIG. 6 depicts the Generalized Edge Compute (GEC) architecture of this disclosure.

### DETAILED DESCRIPTION OF THE INVENTION

### Content Delivery Networks

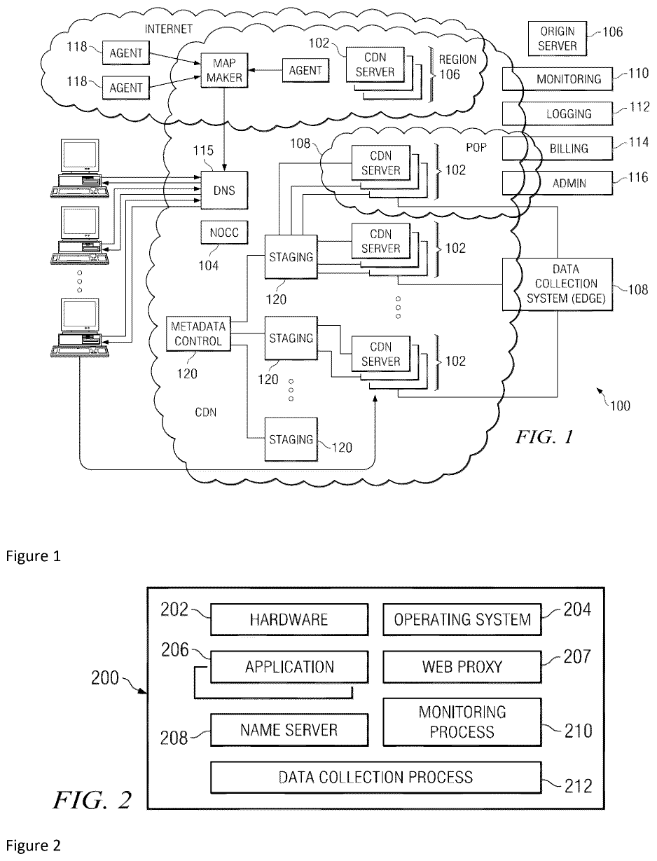

In a known system, such as shown in FIG. 1, a distributed computer system 100 is configured as a content delivery network (CDN) and is assumed to have a set of machines 102a-n distributed around the Internet. Typically, most of the machines are servers located near the edge of the Internet, i.e., at or adjacent end user access networks. A network operations command center (NOCC) 104 manages operations of the various machines in the system. Third party sites, such as web site 106, offload delivery of content (e.g., HTML, embedded page objects, streaming media, software downloads, and the like) to the distributed computer system 100 and, in particular, to “edge” servers. Typically, content providers offload their content delivery by aliasing (e.g., by a DNS CNAME) given content provider domains or sub-domains to domains that are managed by the service provider's authoritative domain name service. End users who desire the content are directed to the distributed computer system to obtain that content more reliably and efficiently. Although not shown in detail, the distributed computer system may also include other infrastructure, such as a distributed data collection system 108 that collects usage and other data from the edge servers, aggregates that data across a region or set of regions, and passes that data to other back-end systems 110, 112, 114 and 116 to facilitate monitoring, logging, alerts, billing, management and other operational and administrative functions. Distributed network agents 118 monitor the network as well as the server loads and provide network, traffic and load data to a DNS query handling mechanism 115, which is authoritative for content domains being managed by the CDN. A distributed data transport mechanism 120 may be used to distribute control information (e.g., metadata to manage content, to facilitate load balancing, and the like) to the edge servers.

As illustrated in FIG. 2, a given machine 200 comprises commodity hardware 202 running an operating system kernel (such as Linux or variant) 204 that supports one or more applications 206a-n. To facilitate content delivery services, for example, given machines typically run a set of applications, such as an HTTP proxy 207 (sometimes referred to as a “global host” process), a name server 208, a local monitoring process 210, a distributed data collection process 212, and the like.

A CDN edge server is configured to provide one or more extended content delivery features, preferably on a domain-specific, customer-specific basis, preferably using configuration files that are distributed to the edge servers using a configuration system. A given configuration file preferably is XML-based and includes a set of content handling rules and directives that facilitate one or more advanced content handling features. The configuration file may be delivered to the CDN edge server via the data transport mechanism. U.S. Pat. No. 7,111,057 illustrates a useful infrastructure for delivering and managing edge server content control information, and this and other edge server control information can be provisioned by the CDN service provider itself, or (via an extranet or the like) the content provider customer who operates the origin server.

The CDN may include a storage subsystem, such as described in U.S. Pat. No. 7,472,178.

The CDN may operate a server cache hierarchy to provide intermediate caching of customer content; one such cache hierarchy subsystem is described in U.S. Pat. No. 7,376,716.

The CDN may provide secure content delivery among a client browser, edge server and customer origin server in the manner described in U.S. Publication No. 20040093419. Secure content delivery as described therein enforces SSL-based links between the client and the edge server process, on the one hand, and between the edge server process and an origin server process, on the other hand. This enables an SSL-protected web page and/or components thereof to be delivered via the edge server. To enhance security, the service provider may provide additional security associated with the edge servers. This may include operating secure edge regions comprising edge servers located in locked cages that are monitored by security cameras.

As an overlay, the CDN resources may be used to facilitate wide area network (WAN) acceleration services between enterprise data centers (which may be privately-managed) and third party software-as-a-service (SaaS) providers.

In a typical operation, a content provider identifies a content provider domain or sub-domain that it desires to have served by the CDN. The CDN service provider associates (e.g., via a canonical name, or CNAME) the content provider domain with an edge network (CDN) hostname, and the CDN provider then provides that edge network hostname to the content provider. When a DNS query to the content provider domain or sub-domain is received at the content provider's domain name servers, those servers respond by returning the edge network hostname. The edge network hostname points to the CDN, and that edge network hostname is then resolved through the CDN name service. To that end, the CDN name service returns one or more IP addresses. The requesting client browser then makes a content request (e.g., via HTTP or HTTPS) to an edge server associated with the IP address. The request includes a host header that includes the original content provider domain or sub-domain. Upon receipt of the request with the host header, the edge server checks its configuration file to determine whether the content domain or sub-domain requested is actually being handled by the CDN. If so, the edge server applies its content handling rules and directives for that domain or sub-domain as specified in the configuration. These content handling rules and directives may be located within an XML-based “metadata” configuration file.

More generally, the techniques described above are provided using a set of one or more computing-related entities (systems, machines, processes, programs, libraries, functions, or the like) that together facilitate or provide the described functionality described above. In a typical implementation, a representative machine on which the software executes comprises commodity hardware, an operating system, an application runtime environment, and a set of applications or processes and associated data, which provide the functionality of a given system or subsystem. As described, the functionality may be implemented in a standalone machine, or across a distributed set of machines. The functionality may be provided as a service, e.g., as a SaaS solution.

Because the CDN infrastructure (or “edge platform”) is shared by multiple third parties, it is sometimes referred to herein as a multi-tenant shared infrastructure. The CDN processes may be located at nodes that are publicly-routable on the Internet, within or adjacent nodes that are located in mobile networks, in or adjacent enterprise-based private networks, or in any combination thereof.

As used herein, an “edge server” refers to a CDN (overlay network) edge machine or server process used thereon. In the above-described context, a “region” typically is a set of edge servers or machines that are co-located with one another. More formally, a “region” or “cluster” typically is a collection of machines in a single location within a given region that share equivalent front-end network connectivity and also share a local back-end network. A set of such regions and associated network infrastructure (e.g., within a metropolitan area or “metro”) that shares connectivity to the Internet is sometimes referred to herein as an Equivalence-Class-Of-Region (“ECOR”). There may be multiple ECORs in any given city (although there may be cases where an ECOR spans physical nearby buildings, such as with DWDM interconnects).

The edge platform as described is a deployed network designed to manage large numbers of distributed servers in a distributed fashion. To this end, and in one non-limiting embodiment, the platform leverages an underlying Linux-based operating system (OS) (e.g., a Linux kernel version that is Ubuntu-based). A Linux kernel version of this type (sometimes referred to herein as Linux Server Install (LSI)) may have one or more supporting services such as log aggregation, data aggregation and query reporting, secret management, and the like. Using the LSI and its related services, the system provides for: deploying and managing servers at scale; role-based and standards-compliant remote access control and audit functionality; a secret management system for distributing key materials; a Network Operations Control Center (NOCC) for tooling and expertise managing systems; a platform that incorporates ways to distribute critical control information with multiple safety features built-in, and techniques for keeping server BIOS and firmware up-to-date. The LSI is readily patched and features can be added thereto as needed.

### Cloud Computing

As noted, cloud computing is a model of service delivery for enabling on-demand network access to a shared pool of configurable computing resources (e.g., networks, network bandwidth, servers, processing, memory, storage, applications, virtual machines, and services) that can be rapidly provisioned and released with minimal management effort or interaction with a provider of the service. Available service models that may be leveraged in whole or in part include: Software as a Service (Saas) (the provider's applications running on cloud infrastructure); Platform as a service (PaaS) (the customer deploys applications that may be created using provider tools onto the cloud infrastructure); Infrastructure as a Service (IaaS) (customer provisions its own processing, storage, networks and other computing resources and can deploy and run operating systems and applications). Typically, the cloud computing environment has a set of high level functional components that include a front end identity manager, a business support services (BSS) function component, an operational support services (OSS) function component, and the compute cloud components themselves.

A representative cloud computing infrastructure is implemented in a data center operated by a virtual machine (VM) hosting provider. A representative provider is Linode®, now owned by Akamai Technologies, Inc., of Cambridge, Massachusetts. In this infrastructure, a “Host” refers to a bare-metal machine running software. A “Compute Host” is a machine that manages virtual machines VMs and typically runs associated administrative software for a cloud compute infrastructure. A “Guest VM” is a virtual machine running on a Compute Host, and it may be a customer VM or an infrastructure VM. A “Datacenter” (CD) typically is a customer-facing abstraction for cloud compute infrastructure, typically a cluster of Guest VMs.

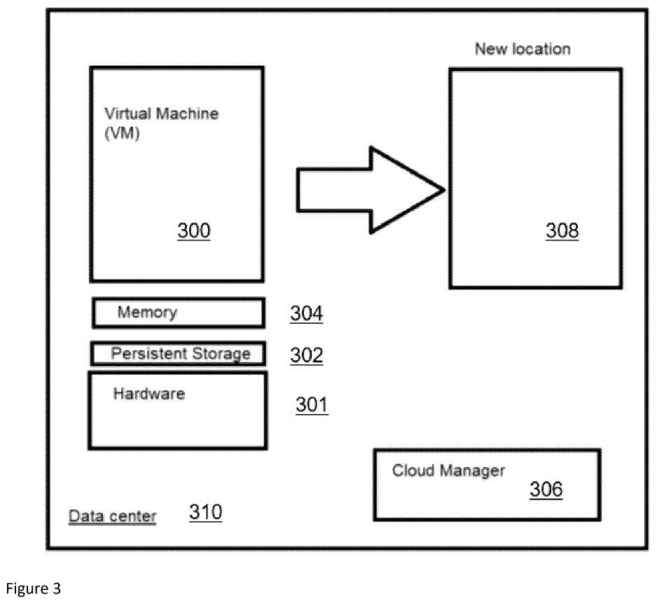

A representative VM is depicted in FIG. 3. The VM 300 has associated therewith persistent storage 302, the amount of which typically varies based on size and type, and memory (RAM) 304, both of which are associated with hardware 301. The local persistent storage typically is built on enterprise-grade SSDs (solid state disks). The VM's persistent storage space can be allocated to individual disks. Disks can be used to store any data, including the operating system, applications, and files. A representative VM is equipped with two (2) disks, a large primary disk used to store the OS distribution (typically Linux), software, and data, and a smaller swap disk, which is used in the event the VM runs out of memory. While two disks are typical, the VM can be configured to have many more disks, which can serve a variety of purposes including dedicated file storage or switching between entirely different Linux distributions. When multiple disks are added to a VM, configuration profiles are used to determine the disks that are accessible when the VM is powered on, as well as which of those disks serves as a primary root disk. Using tools provided by the service provider, disks can be created, resized, cloned and deleted. In addition, and by using a cloud manager 306, the VM can be migrated to another data center (if the provider operates multiple data centers), or to another location 308 within the datacenter 310.

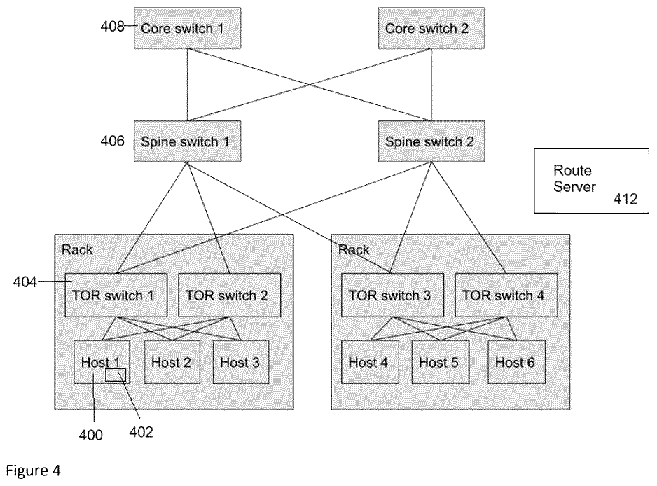

FIG. 4 depicts a representative core site (a datacenter) that supports a known cloud compute infrastructure. As depicted, this architecture is based on a non-blocking, multistage switching network (e.g., CLOS) with Border Gateway Protocol (BGP) as the routing protocol between switches. As depicted, the Hosts 400 are physical boxes that contain the Guest VMs 402. As illustrated, each host is connected with two TOR (Top-Of-Rack) switches 404 with one physical ethernet cable to each of them. A Top-of-Rack router or switch is a network that provides connectivity between Hosts in a rack and between those Hosts and the rest of a network fabric, transit, or other such connectivity. Upstream (north) of the TOR is a set of leaf or bolt routers, in this example spine 406 and core 408 switches, which connect to the core switches 410. Routing between hosts and switches is done through BGP; all switches and hosts speak BGP with switches and hosts they have a physical connection with. In addition, typically the hosts 400 have an eBGP connection with one or more instances of a route server 412, which acts as a distributed network controller. The route server 412 may execute a route server manager process that performs leader election and starts/stops route server instances as needed. The hosts 400 use an Internet routing protocol suite (e.g., FRR or FRRouting) to establish eBGP connections to the TORs and route servers and install routes in the Linux kernel.

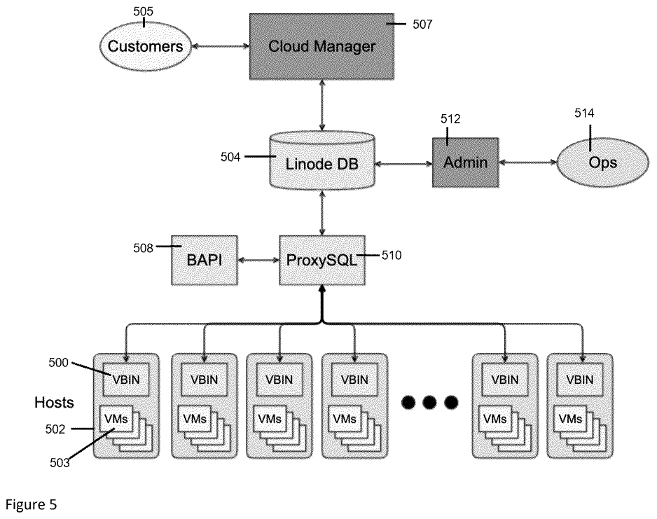

The above-described core site is managed by a control plane that is now described and depicted with reference to FIG. 5. In a representative embodiment, a core site runs a software package that operates as a host engine 500 (referred to as VBIN). The host engine 500 manages virtual machines 503 (among other things) on a host 502. The host engine 502 interoperates with a network-accessible database 504, which may be located remotely from the host. The host engine 500 executes an allocator that is responsible for placing workloads onto available hardware. The job of the allocator, which may be implemented in the form of a Python function (e.g., get host), is to balance load across hardware in a customer-selected compute region, and to ensure that IP addresses, disk space, “slots”, all have availability to accept the new workload. The database 504, which may be implemented as a MySQL instance, is a singleton that acts both as a data source and as a message bus. In particular, the database 504 acts as a message bus among end users (customers 505) interacting with the cloud compute service (typically accessed via a Cloud Manager 507 at a secure network-accessible domain), the allocator making VM placement decisions, and one or more other compute infrastructure hosts performing jobs in service of end user requests. For example, when an end user creates a guest VM on the compute service, a series of jobs are inserted into the database 504 with a Host Identifier (Host ID) selected by the allocator. When that host wakes up from sleeping and looks for work in the database 504, it finds those jobs and starts executing on them. As a result, the compute host 502 here creates the guest VM 503, sets up its volumes and networks, and boots the guest VM, e.g., with QEMU. QEMU is a generic and open source machine emulator and virtualizer. It emulates a computer's processor through dynamic binary translation and provides a set of different hardware and device models for the machine, enabling it to run a variety of guest operating systems. It can interoperate with Kernel-based Virtual Machine (KVM) to run virtual machines at near-native speed, and it can also emulate user-level processes, allowing applications compiled for one processor architecture to run on another. QEMU also has a migration framework that the host engine uses to move a guest VM from machine to machine. Error handling and observability are all sent back to the database 504 and reflected in a service user interface (UI) dashboard. Within this service, the datacenter acts as a compute boundary. In an example implementation, a service datacenter then is a formal entity in the database 504 and is the boundary into which customers select and deploy compute. As also shown, the site may include a back-end Application Programming Interface (BAPI) 508 that is used by various components in the platform, and data collector boxes 510 that collect individual VM statistics that are used as the data source of the Analytics tab in a Cloud Manager UI exposed by the service. The system may also include an administration function 512, and an operations function 512.

In a representative embodiment, the control plane described above is managed “as-a-service” from a secure web application available, e.g., from a service provider domain or subdomain. After becoming a customer, secure permissioned access to the control plane is provided to enable the customer to provision and manage its workloads in the compute infrastructure.

### Generalized Edge Compute

According to a first feature of this disclosure, virtual machine provisioning and management by the above-described control plane is configured in one or more edge sites hosted within overlay network (e.g., CDN) regions and ECORs. More formally, Generalized Edge Compute (GEC) as provided herein (sometimes referred to as Distributed Compute) includes the notion of migrating compute instances such as depicted in FIG. 5 out of a core site (e.g., a datacenter) and into locations within the overlay network edge, e.g., in edge access networks including, without limitation, those networks in metropolitan areas, in emerging markets, and the like. In so doing, the techniques herein address the goal of bringing compute closer to the end user, which is a core value proposition of well-designed and implemented overlay network solutions. To this end, and in one embodiment, GEC comprises a host engine running on overlay network edge hardware and software (e.g., LSI) for the purposes of supporting generalized compute workloads. The term “generalized” in this context implies both compute that is not tied to the delivery of objects through a CDN, as well as software written in any programming language that runs within the context of a virtual machine.

The techniques described here provide significant advantages. Generalized Edge Compute transforms the cloud marketplace and takes cloud computing to the edge by embedding cloud computing capabilities into a highly-distributed overlay edge network. This solution combines the computing power of the cloud compute infrastructure with the proximity and efficiency of the edge to put workloads closer to users. While traditional cloud providers support VMs and containers in a relatively small number of core data centers, the approach herein extends this capability to edge Points of Presence (PoPs), bringing full stack computing power to hundreds of previously hard to reach locations. Deploying compute into an edge platform also takes advantage of existing operational tools, processes, and observability-enabling developers to innovate across the entire continuum of compute, providing a consistent experience from centralized cloud to distributed edge.

Provisioning the host engine onto the edge network enables a cloud compute solution that is highly distributed and that leverages the overlay network LSI-supported ancillary features and functions that include, without limitation, data aggregation, log aggregation, NOCC support, safety features (zones, rollbacks), compliance (PCI, etc.), secrets, reliable configuration distribution, and role-based, standards-compliant, auditable remote access.

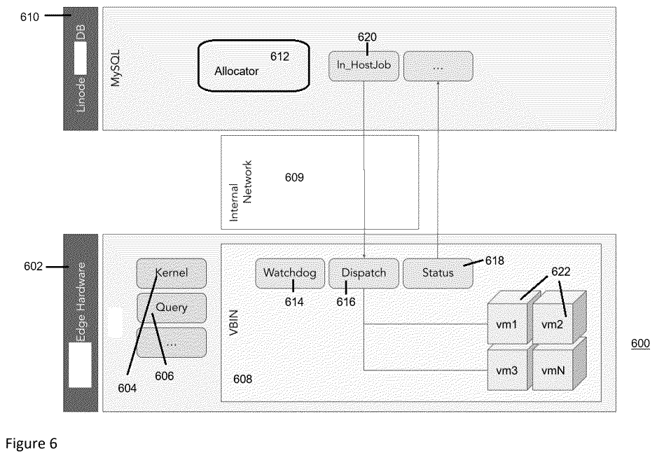

FIG. 6 depicts a representative implementation of the above-described control plane on an overlay network edge machine 600. In this example, the edge machine 600 comprises hardware 602, and the edge machine operating system (OS) 604 and supporting services 606. Here, compute host engine 608 has been delivered to the edge machine over the internal CDN network 609, and it is configured to run on the OS 604 as previously described. As depicted, this host engine 608 interoperates and communicates with a remote database (DB) 610, which, together with the allocator 612, forms part of the cloud compute control plane. The database 610 holds configuration data and system state, and it is accessed directly by host engine 608. As previously noted, the database provides a message bus function between and among end users (e.g., customers) interacting with web application compute service platform, the allocator 612 making VM placement decisions, and compute hosts (in this case host engine 608 executing on top of LSI in the overlay edge machine) performing jobs in service of those end user requests. In this embodiment, the host engine 608 includes a watchdog function 614, a dispatch function 616, and a status function 618. The allocator 612 makes the VM placement decisions and runs an In_Host job 620 to implement them on the host engines, one of which is shown. The In_Host job refers to an In_Host table, which for each host defines a set of “slot type” capacities, and this table is consulted when attempting to place workloads on hosts. Preferably, the compute infrastructure provider implements one or more plans, wherein a plan defines an amount of CPU, RAM, disk, and network ingress/egress to which a VM is entitled when a compute service is purchased. Without intending to be limiting, plans can be “shared,” meaning the resources are shared amongst other shared plans in an oversubscribed fashion, or “premium,” meaning CPU and RAM resources for a VM are dedicated. These categories are merely exemplary. Generally speaking, and in response to a customer provisioning request, the allocator 612 checks whether the slot type for a selected plan has capacity on the host. In this example, the allocator has determined that a VM is configurable on the edge machine. The allocator then configures the one or more jobs in the database (e.g., as a series of jobs) with a Host Identifier (Host ID) uniquely associated with the compute host engine 608 running on the edge machine.

In this example, the watchdog function 614 is responsible for waking up the host engine and instructing it to look for new work. In response, the host engine reaches out over the internet network 609 and finds the new job. The dispatch function 616 receives the job and manages the provisioning of the virtual machines 622. The status function 618 reports back its progress. Generalizing, the compute host engine creates the new VM, sets up its associated volumes and networks, and boots the VM. e.g. using QEMU running locally.

One technique to facilitate deploying or instantiating new overlay network edge regions with compute enabled involves mapping those regions (e.g., using DNS-based mapping) with respect to an existing compute datacenter. Several options exist to map overlay network edge regions to a datacenter, namely, as a single edge machine region, as an ECOR (a set of such regions), some arbitrary set of regions, perhaps one per-ECOR in an availability zone topology, and as a larger set of regions (or perhaps all regions) as a single compute “edge” datacenter. In one non-limiting embodiment, a region comprises a single rack that shares one or more (and preferably a pair of ToRs) with typically a large number (e.g., more than 20) Hosts, and multiple regions in the same ECOR comprise a Datacenter (DC)

The above-described Generalized Edge Compute solution enables customers to deploy their applications in a VM environment hosted on overlay network hardware and software, thereby leveraging all of the advantages provided by a widely-distributed overlay. The approach enables customers (whether CDN, compute, or both) to host bandwidth-intensive applications, generate Web-like traffic, mix both traffic patterns, and to implement new traffic profiles. In addition, the solution provides a multi-tenant approach to hosting multiple customer VMs onto edge network hardware, and GEC customers can run any type of workload at any time while leveraging all the benefits of the edge network.

### Overlay Network Traffic Management

By way of additional background, the overlay network typically includes a mapping functionality that directs resource requests (e.g., overlay network-specific hostnames) to regions (typically groups of co-located machines) and servers within those regions. The mapping functionality may also include a resource management component (RM) that assigns bandwidth targets for regions and links associated with those regions. Generally, this component attempts to manage the load on each link by adjusting the capacity of regions, ECORs, and links given to the one or more load balancing functions (which may be global- or region-based). The management component considers link demand data (e.g., an amount of demand assigned to a link).

The following glossary provides additional information regarding link types and link capacity allocation with respect to an overlay network, such as the CDN described above.

Physical links are one or more physical circuits connecting two entities (e.g., connections from an ECOR (router) to a provider (router)). If there is more than one physical circuit, an associated routing layer load evenly balances load across them.

Virtual links are logical connections, e.g., between an ECOR and another entity. A virtual link is defined by (1) the parent link the load physically traverses and (2) a set of CIDRs. Whenever a physical link has at least one virtual link there is also a default virtual link created to capture all load not on any defined virtual link.

Parent links refer to link(s) upstream from a virtual link that the reported load traverses over.

Child links refer to virtual link(s) downstream of a physical link where traffic will be assigned. A physical link can have multiple child links.

Leaf links are the links that appear in a linkID tree and are the most specific link(s) used for traffic. Leaf links are often child virtual links, but when a physical link has no virtual links, the leaf link is a physical one.

Shared links (sometimes referred to as bottleneck links) typically are physical link(s) to a router. To manage capacity on shared links, the link's capacity typically is divided into virtual links

Mega virtual links are a group of virtual links serving the same CIDR space where each virtual link has a different parent link.

The following are physical link capacity terms.

SNMP Capacity refers to physical link capacity as measured on router interfaces comprising the link.

Planner Capacity (planner_cap) refers to a given percentage of the SNMP Capacity.

Adjuster Capacity (adjuster_cap) is a variable that is used by the resource management component (the “manager”) that assigns bandwidth targets for regions and links. As noted above, the manager attempts to manage load on each link by adjusting the capacity of the regions, ECORs and links given to load balancing components that are under the control of the CDN. In a representative use case, the adjuster_cap may be set to planner_cap but can be reduced, e.g., a link suspension or overload.

Virtual links do not have any notion of an SNMP or Planner Capacity. A virtual link's link_capacity typically is just a configured link capacity value. A virtual link may also have an adjuster_cap that is computed by capping the link_capacity by a parent link adjuster_cap and subtracting any non-mapped CDN load (or some multiple thereof) present on the virtual link.

### Link Safety

As noted, when GEC customers wish to place traffic on CDN links (e.g., using their own load balancers), they do so without any visibility into CDN traffic demand and available link capacity. This scenario, which is addressed by the subject matter of this disclosure, has the potential to cause congestion on the CDN network, thereby negatively impacting CDN and other services running on the overlay network platform, and to overload egress links, thereby leaving minimal bandwidth for other CDN services. The techniques now described address this problem.

To this end, this disclosure describes a link safety mechanism configured to limit egress traffic for customers, especially high-bandwidth GEC customers. The approach herein is sometimes referred to herein as GEC Link Safety (egress-only). In non-saturation scenarios, preferably the GEC network is allowed to use as much capacity as it needs, while leaving bandwidth for other services and preventing congestion on the link. According to this disclosure, however, when a link is determined to be approaching (or is at) saturation, the link safety mechanism is engaged to perform a mitigation, typically in the form of a throttling action. To that end, and in one embodiment, GEC traffic on the link is reduced to a configurable amount of link capacity. Further, and according to the link safety methods herein, bandwidth allocation among VMs preferably is maximized in favor of VMs that need the most bandwidth at the time of any throttling action while allocating a share proportional to a VM plan size (e.g., in terms of vCPU count) in the case of bandwidth scarcity. Further, preferably only VMs exceeding their bandwidth share are then rate-limited (e.g., by the host engine). In this approach, egress traffic is rate-limited according to the active plan (the “service”) the VM is being billed under. In one embodiment, this rate limit is applied by the host engine using local resources, e.g., a Linux Traffic Control (LTC) subsystem that helps in policing, classifying, shaping, and scheduling network traffic. Adjustments to the rate limit of an individual VM are then surfaced in an administrator dashboard for visibility, preferably via a host job queue for that particular VM instance. The dashboard enables the customer to monitor egress and ingress bits per VM instance.

Stated another way, preferably GEC traffic is not throttled while it is under its minimum bandwidth threshold. If, however, link load is high and GEC traffic exceeds its minimum share on the link, some GEC VMs are throttled (rate-limited) to bring the total GEC usage down to reduce the link utilization. Rate-limiting may be triggered by NOCC alerts or other conditions/triggers, and it may be carried out by the host engine, e.g., via Linux TC or other system automation/tooling.

Preferably, the above-described functions (rate-limits to VMs) are carried out in an automated fashion, rate-limits per VM are updated no more than once per configured time-period (e.g., one (1) minute), and rate-limits are applied within a given time (e.g., one (1) minute) of detection of congestion. In a variant embodiment, rate limiting may also be enforced based on a customer prioritization scheme that is also proportional in nature. In this variant, higher priority customers are rate-limited less than lower priority customers. Rules that determine how rate limits get applied in this embodiment may be configurable via an administrator user interface.

When the GEC network is configured on edge machines in an ECOR, the GEC traffic management preferably also is controlled according to the dynamic conditions in the ECOR. The link safety mechanism may be implemented in or in association with many different types of link architectures including, without limitation, FABRIC, MLE+ (SDN-controlled), and MLE ECORs.

To facilitate link safety, the overlay network hosts (including those that support the GEC functionality as described herein) report statistics for how much traffic each host is egressing on each link.

For reporting and tracking purposes, the system may provide a network-accessible dashboard that reports per-VM, per-customer, and per-link statistics.

The following provides a more detailed description of a representative embodiment of the above-described link safety mechanism.

According to this embodiment, VMs are rate-limited (e.g., via TC) to the bandwidth specified in the VM plans. This limit ensures that the total egress traffic from the VM does not exceed the official bandwidth. Link Load Reporting (LLR) is implemented to keep track of the GEC-related traffic on links. When the total GEC traffic on any given link exceeds a GEC link capacity, a given action occurs. For example, on this occurrence, a NOCC-visible (or the like) alert is raised. When the alert fires, a Site Reliability Engineering (SRE)-provided tool is executed to calculate each VM's bandwidth share on the impacted link. The bandwidth share is called the VM's fair-share value on the link. As will be described in more detail below, a fair-share algorithm is executed to determine each VM's fair share of the link. VMs egressing more traffic than their fair-share value are then rate-limited to their fair-share value on the link. In this example embodiment, this rate-limiting is accomplished by the SRE tool, which in one implementation uses the Linux TC (LTC) command to rate-limit the VMs for a given alert instance. A follow-on alert may then be raised when the GEC load on the link is under the GEC link capacity for over a configurable cool-off period; the NOCC-script (or other control tooling) responds to this follow-on alert and removes the rate limits via an SRE-provided tool.

In a further variant, Link Load Reporting is also used by GEC hosts to report a per-VM utilization of each link, and this report helps identify VMs that exceed their fair-share value of the link capacity. To this end, an agent executing in association with the host engine samples VM traffic on virtual network interfaces (tap devices) with a configurable sampling rate. The sample traffic includes source and destination IP addresses, which are used to identify the link to which the traffic belongs. The sampled traffic is sent to a host-specific load balancing component that is responsible for balancing requests (received in-region) to co-located hosts. The load balancing components uses source and destination IP addresses reported in the sampled traffic and performs a look up against a data feed to identify which link the traffic belongs to; it then aggregates traffic per link over a time window. Preferably, this aggregation is done across all VMs running on the host and thus does not contain VM-specific traffic statistics. The aggregated traffic per link is reported to back to the overlay network mapping system, where it is then used to facilitate other mappings. When the total GEC traffic on a link exceeds some configurable value (e.g., 2%, 5%, and 10%) relative to the link's capacity, one or more actions may be taken (e.g., raising an alert, NOCC-triggered traffic rate limiting to prevent congestion on the link, diverting traffic away from the link via other load balancing mechanisms, and the like).

By way of example only, the GEC link capacity for each link may be determined by applying a configured threshold to the link capacity that takes certain variables into consideration, such as an amount of expected demand to assign to a link, and an amount of expected traffic over the link from other non-GEC traffic sources. As has been described, in this embodiment VMs can use as much link bandwidth as they wish (e.g., each up to their bandwidth cap as per the VM plan) until the alert fires and a NOCC action is needed to bring the total GEC traffic within the safety limits. When a NOCC action is required, each VM is assigned a portion of the link bandwidth out of the link capacity limits defined for GEC for the link. This portion is called fair-share of the VM for the link in question. Preferably, and as noted above, bandwidth allocation for VMs is maximized in favor of VMs that need the most bandwidth at the time of the throttling action while allocating a share proportional to VM plan size (in terms of vCPU count) in the case of bandwidth scarcity.

The link safety mechanism may also take advantage of or interoperate with existing overlay network safety functionality. Thus, for example, and for links with low headroom, overlay network mapping functions can be configured to steer CDN traffic off of those links. In addition, if a GEC customer having known high bandwidth requirements is on-boarded, this can be taken into consideration in managing capacity arrangements that are established for the hosts.

### GEC Link Capacity

In a representative implementation, a GEC Link Capacity is calculated for each link by applying a configured threshold to the link capacity. In one embodiment, the resource management component sets the link capacity to be:

$$GEC\_Cap \_L = min ( T\_L * Max ( 0.5 * planner\_cap \_L , adjuster\_cap \_L ) , planner\_cap \_L - unctrl\_thresh * uncontrollable\_non \_gec \_load \_L )$$

where,
unctrl_thresh=configurable threshold, e.g., set between 1 and 1.1; and
uncontrollable_non_gec_load_L=all non-GEC uncontrollable traffic on link L

The T_L in the first term in the minimum clause is a threshold value set for the total GEC traffic allowed on a given link. In one embodiment, this value is initially set to 20% (0.2). This is not a limitation. Depending on additional bandwidth requirements for the GEC traffic, this percentage may be adjusted to a higher or lower value. The remaining term defines that the threshold value preferably applies to a combination of planner_cap and adjuster_cap values. The benefit of incorporating the adjuster_cap is that the GEC link cap percentage is then based on the actual capacity available to the CDN, as the adjuster_cap reflects changes due to various factors such as manual caps, circuit imbalance, and overloads. The second term in the minimum clause ensures that the GEC link capacity is less than the space on the link left after other uncontrollable traffic (which may be difficult to move away from the link if GEC uses more than the remaining). This is useful to incorporate because if the GEC load exceeds the planner_cap_L−uncontrollable_non_GEC_load_L, congestion may result.

### VM Fair-Share Algorithm

As noted above, in an example embodiment VMs are configured to use a much link bandwidth as they wish (each up to their bandwidth cap as per a VM plan) until a given occurrence (e.g., an alert fires) and some throttling action (e.g., a NOCC action) is needed to bring the total GEC traffic within safety limits. When the action is required, according to one embodiment herein each VM is assigned a portion of the link bandwidth out of the link capacity limits defined for GEC. This is the so-called “fair-share” of the VM for the link in question. As noted, preferably bandwidth allocation for VMs should be maximized in favor of VMs that need the most bandwidth at the time of the throttling action while allocating a share proportional to VM plan size (e.g., in terms of vCPU count) in the case of bandwidth scarcity. The fair-share algorithm that is now described operates to distribute a given portion of the link bandwidth among GEC VMs based on the VM characteristics (such as, for example, vCPU count and the VM bandwidth cap) and each VM's utilization of the link capacity at the time of alert firing. This allocation ensures that bandwidth is distributed fairly, and it prevents abuse by smaller VMs when a corrective action is needed.

By way of further background, a VM Plan typically includes a data set that defines an amount of dedicated traffic, a monthly cost for such dedicated bandwidth, a number of vCPUs, and allocated network ingress/egress ratio. Thus, a first representative VM Plan may be {4 GB, monthly cost x, 2 vCPUs, and 4 Gbps/4 Gbps}, while another plan may be {16 GB, monthly cost y, 8 vCPUs, and 6 Gbps/6 Gbps}. These are examples only.

In the example embodiment, the following terms are used for calculating the fair-share for each VM on a given link at the time of the corrective (throttling) action. The total link capacity for the relevant link allowed for GEC traffic is X. The number of GEC VMs provisioned to have access to the relevant link is N. A virtual CPU count of the i^{th} VM is vCPU. The i^{th} VM's bandwidth cap is Bi. A current rate limit (if any) applied to the i^{th} VM for relevant link is Lᵢ. A latest measurement of the relevant link bandwidth utilized by the i^{th} VM is Uᵢ. A “fair-share” of the link bandwidth for the i^{th} VM is then computed as FSi as follows below. The algorithm is iterative, and it keeps refining fair VM bandwidth allocation until no more refinements can be made. For each iteration, the algorithm computes “fair-share” for the bandwidth given the link capacity available to the users, here the VMs). Then, the algorithm identifies users who are below the new “fair-share” threshold, reducing the available link bandwidth for the remaining users for a next iteration. The algorithm terminates when no further progress can be made, meaning that all remaining users are above their fair share (or there are no users remaining). Formally, the algorithm is as follows:
1. Compute

$$F {S}_{i} = X * {vCPU}_{i} \div {Σ}_{j = 1}^{N} {vCPU}_{j}$$

2. For all VMs with Uᵢ≤FSᵢ:
   a. The i^{th} VM is eliminated from the set of VMs for the next iteration.
   b. If the current link rate limit Lᵢ exists for the i^{th} VM:
      i. If Uᵢ+ϵ≤Lᵢ:
         1. Remove the link rate limit from the i^{th} VM
      ii. else:
         1. Update the link rate limit Lᵢ=FSᵢ
         2. Consider Uᵢ=FSᵢ for step 2c below
   c. Remaining link bandwidth X is reduced by Uᵢ for the next iteration
3. Stop the algorithm if there are no VMs remaining or no VMs were removed in step 2. The FSᵢ values are the rate limits for the relevant link for the remaining VMs.

Once the algorithm finishes, it produces per-VM per-link rate limit decisions as FSᵢ for the remaining VMs (as well as decisions to remove or update per-VM per-link rate limits). In one embodiment, the algorithm rate-limits the VMs to bring the total GEC traffic to the target GEC bandwidth for the link. If desired, it may be desirable to adjust the target bandwidth to leave some bandwidth headroom in the case the other VMs grow in traffic. This headroom helps delay another alert firing, which might occur otherwise as soon as the traffic grows, and it enables the system to accommodate the traffic growth within GEC safety limits. In one embodiment, the adjusted target bandwidth is some percentage (e.g., 80%) of the target bandwidth X.

In one embodiment, which is not intended to be limiting, an alert (indicating that a link is congested (saturated, or nearly-saturated) is fired when the total GEC traffic on the link exceeds the GEC link capacity and the constraining link utilization is at least some given percentage (e.g., 70%) of the adjuster_cap value.

### VM Rate-Limiting Tool

A representative VM (e.g., SRE-based) rate-limiting tool is now described. The tool collects a data set that comprises utilization by each GEC VM, a tuple indicating the hosts on which the VMs are provisioned, the vPCU count for all VMs using the link, the bandwidth cap for all VMs using the link, and any existing rate limits on the VMs previously applied by the automation/tooling described. The tool may also receive data listing a given number (e.g., 20) of CIDR blocks consuming the most bandwidth on the impacted link with a given source IP address. Using the above information, the tool computes the fair-share value for each VM using the impacted link, per the algorithm described above. Based on the computation, the tool then identifies (1) VMs that exceed their fair-share value and thus need to be rate-limited; (2) VMs that already have a rate limit placed for the link and need their rate limits to be updated; and (3) VMs whose existing rate limits need to be deleted. In this embodiment, the rate limit applied is the VM's fair share value for the impacted link, and preferably this limit is also applied to the given number of most bandwidth-consuming CIDRs on the impacted link. If the list of top CIDRs is unavailable, a default value of 0.0.0.0/0 is passed to the host, which serves to rate-limit all traffic on the VM. Preferably, the host is instructed to rate-limit only the top number of CIDRs, as opposed to all the traffic on the impacted link. To carry out the rate-limiting, the tool initiates an SSH session with the GEC host machine. Then, for each VM that needs to be rate-limited, the SRE tool creates (or updates if it already exists) a local file in a local directory. The file contains a JSON object comprising the CIDRs to be rate-limited on the VM, corresponding rate limits (typically CIDRs from the same link have the same limit), and a unique handle. A local file on the GEC host may be created to keep track of all active rate limits on the VM, including the active rate limits applied previously. The SRE tool invokes a host engine handler, which reads the JSON file and passes it into an SQL insert command, thereby creating a new job in the GEC database, to cause the changes to be implemented.

The above-described link safety mechanism may interoperate with existing overlay network control mechanisms, such as the resource manager (RM) component described. Traditionally, and for the CDN traffic use case, the RM component provides other overlay network mapping components with load and allowed bandwidth on a link for the CDN traffic to use. However, and as explained above, the GEC network does not use those mapping components (for link load balancing or otherwise). Rather, it is assumed that the GEC traffic is being placed on the link by an external (to the CDN) load balancer. According to a further aspect here, the RM may provide an additional service, namely providing information about the link load and allowed capacity on each link to that external load balancer. In an example embodiment, this is done by looking at all uncontrollable and controllable load sources of varying priorities and other network health metrics (such as ongoing maintenance, link imbalance issues, and active overload conditions) to dynamically calculate a safe capacity value for each resource (in this case, the link) and that maximizes the service's requested capacity without jeopardizing or overloading the resource. This information is computed for all link types, including virtual/logical and physical links, so that the real source of any network bottleneck can be identified and safety measures applied to it. The output of the RM service, e.g., link load data, is consumable by a subscribing component (in the example the external GEC load balancer) to keep the overlay network free from congestion and performance degradation issues. The subscribing component may also be a traffic control (e.g., a VM rate limiting tool) that restricts the amount of a particular kind of traffic that can placed on link.

### Variants

It is desired that the time between raising an alert and applying rate limits to impacted VMs will be as short as possible. A preferred implementation approach is to apply automation and tooling to ensure that the solution exhibits low latency. In addition, there may be scenarios where default fair-share and rate-limiting algorithms as described above are subject to being overridden, e.g., by an applicable business or security policy, or where dynamic thresholds may be implemented to maximize system performance. In a representative example, the system may learn to relax configured limits for the link when the overall link load is not close to capacity or if the link is being used by lower-priority traffic that could move away.

In one variant embodiment, the system is configured with a link load controller in lieu of the alerting and NOCC-enforced rate limiting functions described above. The link load controller receives information (described below). Using that information and the fair-share algorithm described above, the link load controller computes new rate limits (add, remove or adjust) for the VMs, and sends these rate limits to the host(s). The link load controller may comprise a component of the overlay network mapping system, and an instance may be responsible for a subset of ECORs in the network. Alternatively, there is a link load controller associated with an ECOR directly.

In the embodiment, the link load controller receives a set of data feeds, preferably sent in real-time or near real-time. These include: (i) the top N CIDRs for each link serving the host, (ii) link load data for each GEC VM, (iii) VM metadata (e.g., maximum bandwidth and vPCU count), and (iv) active rate limits on each GEC VM. The link load controller also receives link thresholds, e.g., from a resource manager in the overlay network mapping system). The VM fair-share algorithm is then executed against this data to determine VMs that need to be rate-limited. During this process, one or more policies may be applied. Thus, for example, certain VMs in the node may be excluded from rate limiting altogether. These exclusions may be based on time-of-day, a tag associated with the VM indicating that the VM has a premium (or the like) status, or some other requirement. Rate limits may be applied to certain VMs only after other VMs have been first rate-limited and the GEC capacity requirements continue to exceed the GEC threshold. Or, the controller may apply a smaller or larger rate limit than the VM's fair-share value. Machine learning may be used to gather an in-depth understanding of when certain traffic policies are impacted by rate-limiting. Once the link load controller computes the rate limits for the VMs that need to be rate-limited, it communicates them to the host control engine, e.g., via a job directly submitted to a host job table in the GEC database. This submission may be carried out via a BAPI interface, e.g., with the controller submitting a JSON object for all the rate limits that apply to the entire set of VMs. Preferably, rate limiting actions are reported to system components, either as they are implemented or periodically.

According to another variant, and prior to rate-limiting a VM, the link load controller could signal other control functions (such as Software Defined Network (SDN)) to move traffic exceeding a computed fair-share value to another link. Alternatively, and if the link is congested, the SDN (or other control function in the overlay) may prioritize CDN over GEC depending on the GEC usage relative to the GEC capacity.

According to another feature, the above-described approach may be extended for additional links such that a same set of VMs may be rate-limited for several links being overloaded at the same time. In an alternative, a same set of VMs may be rate-limited in progression, e.g., such that the rate limits for Link-A are applied at time T1 and impact (say) VM1 and VM2; later, at time T2, assume it is determined that traffic on Link-B needs to be controlled and that the fair-share indicates that only VM2 (and not VM1) needs to be throttled. In this example, only VM2 has rate limits implemented for both Link-A and Link-B. Generalizing, at any given time different VMs can have different rate limits applied for different links.

### Enabling Technologies

Each of the functions described herein may be implemented in a hardware processor, as a set of one or more computer program instructions that are executed by the processor(s) and operative to provide the described function.

The cloud compute infrastructure may be augmented in whole or in part by one or more web servers, application servers, database services, and associated databases, data structures, and the like.

More generally, the techniques described herein are provided using a set of one or more computing-related entities (systems, machines, processes, programs, libraries, functions, or the like) that together facilitate or provide the functionality described above. In a typical implementation, a representative machine on which the software executes comprises commodity hardware, an operating system, an application runtime environment, and a set of applications or processes and associated data, networking technologies, etc., that together provide the functionality of a given system or subsystem. As described, the functionality may be implemented in a standalone machine, or across a distributed set of machines.

Each above-described process, module or sub-module preferably is implemented in computer software as a set of program instructions executable in one or more processors, as a special-purpose machine.

Representative machines on which the subject matter herein is provided may be computing machines running hardware processors, virtualization technologies (including QEMU), a Linux operating system, and one or more applications to carry out the described functionality. One or more of the processes described above are implemented as computer programs, namely, as a set of computer instructions, for performing the functionality described.

While the above describes a particular order of operations performed by certain embodiments of the disclosed subject matter, it should be understood that such order is exemplary, as alternative embodiments may perform the operations in a different order, combine certain operations, overlap certain operations, or the like. References in the specification to a given embodiment indicate that the embodiment described may include a particular feature, structure, or characteristic, but every embodiment may not necessarily include the particular feature, structure, or characteristic.

While the disclosed subject matter has been described in the context of a method or process, the subject matter also relates to apparatus for performing the operations herein. This apparatus may be a particular machine that is specially constructed for the required purposes, or it may comprise a computer otherwise selectively activated or reconfigured by a computer program stored in the computer. Such a computer program may be stored in a computer readable storage medium, such as, but is not limited to, any type of disk including an optical disk, a CD-ROM, and a magnetic-optical disk, a read-only memory (ROM), a random access memory (RAM), a magnetic or optical card, or any type of media suitable for storing electronic instructions, and each coupled to a computer system bus.

While given components of the system have been described separately, one of ordinary skill will appreciate that some of the functions may be combined or shared in given instructions, program sequences, code portions, and the like. Any application or functionality described herein may be implemented as native code, by providing hooks into another application, by facilitating use of the mechanism as a plug-in, by linking to the mechanism, and the like.

The platform functionality may be co-located or various parts/components may be separately and run as distinct functions, perhaps in one or more locations (over a distributed network).

Generalizing, the techniques may be implemented in a computing platform, wherein one or more functions of the computing platform are implemented conveniently in a cloud-based architecture. As is well-known, cloud computing is a model of service delivery for enabling on-demand network access to a shared pool of configurable computing resources (e.g., networks, network bandwidth, servers, processing, memory, storage, applications, virtual machines, and services) that can be rapidly provisioned and released with minimal management effort or interaction with a provider of the service. Available service models that may be leveraged in whole or in part include: Software as a Service (Saas) (the provider's applications running on cloud infrastructure); Platform as a service (PaaS) (the customer deploys applications that may be created using provider tools onto the cloud infrastructure); Infrastructure as a Service (IaaS) (customer provisions its own processing, storage, networks and other computing resources and can deploy and run operating systems and applications).

The platform may comprise co-located hardware and software resources, or resources that are physically, logically, virtually and/or geographically distinct. Communication networks used to communicate to and from the platform services may be packet-based, non-packet based, and secure or non-secure, or some combination thereof. Typically, the cloud computing environment has a set of high level functional components that include a front end identity manager, a business support services (BSS) function component, an operational support services (OSS) function component, and the compute cloud components themselves.

According to this disclosure, the services platform described below may itself be part of the cloud compute infrastructure, or it may operate as a standalone service that executes in association with third party cloud compute services.

What is claimed is as follows:

1. A method for traffic management over a link of a set of one or more links that is utilized for traffic that is a blend of controllable traffic and non-controllable traffic, comprising:
deploying a cloud compute control plane to a network host, the network host being one of a set of distributed hosts comprising a multi-tenant shared infrastructure;
instantiating one or more virtual machines on the network host;
monitoring traffic being served over the link and associated with the one or more virtual machines, the traffic corresponding to at least the non-controllable traffic; and
throttling the non-controllable traffic associated with the one or more virtual machines on the link to ensure that the link does not become congested for the controllable traffic.

2. The method as described in claim 1, further including:
defining a link capacity for the one or more virtual machines;
determining whether the non-controllable traffic associated with the one or more virtual machines is within a configurable threshold of the link capacity; and
based on a determination that the non-controllable traffic associated with the one or more virtual machines is within the configurable threshold of the link capacity, raising an alert.

3. The method as described in claim 2, wherein, in response to the alert, and for each of the one or more virtual machines:
computing a fair share of bandwidth on the link for the virtual machine;
identifying whether the virtual machine is egressing more than the fair share computed for the virtual machine; and
applying a rate limit to the traffic being served over the link by the virtual machine when the virtual machine is identified as egressing more than its fair share for the link.

4. The method as described in claim 3, further including modifying at least one rate limit previously applied to a virtual machine upon a determination that the monitored traffic is within the configurable threshold of the link capacity.

5. The method as described in claim 3, wherein the fair share of the bandwidth on the link is computed based on the link capacity, a current virtual machine utilization of the link, and one or more characteristics of a virtual machine.

6. The method as described in claim 4, wherein the one or more characteristics of a virtual machine are one of: a virtual machine plan value, a cost, a number of virtual CPUs, an amount of RAM, and a bandwidth cap, and combinations thereof.

7. The method as described in claim 4, wherein the multi-tenant shared infrastructure is a content delivery network, the host is an edge machine, and the controllable traffic is associated with customers of the content delivery network.

8. The method as described in claim 2, wherein the one or more virtual machines are permitted to operate without bandwidth constraints while the monitored traffic is below the configurable threshold of the link capacity.

9. The method as described in claim 1, further including prioritizing bandwidth on the link for a first virtual machine over a second virtual machine when the traffic is throttled, wherein the first virtual machine has higher bandwidth allowance and requirement than the second virtual machine as reflected in a virtual machine plan size or vCPU count.

10. The method as described in claim 1, wherein the virtual machines are instantiated on the network host for multiple distinct tenants.

11. The method as described in claim 1, wherein the link is an egress link of a data center.

12. The method as described in claim 1, wherein the data center is associated with a collection of edge regions that together comprise an Equivalence-Class-Of-Region (ECOR).

13. An apparatus, comprising:
one or more hardware processors;
computer memory holding computer program instructions, the computer program instructions comprising program code configured to provide traffic management over a link of a set of one or more links that is utilized for traffic that is a blend of controllable traffic and non-controllable traffic, the program code configured to:
monitor traffic being served over the link and associated with the one or more virtual machines, the traffic corresponding to at least the non-controllable traffic; and
throttle the non-controllable traffic associated with the one or more virtual machines on the link to ensure that the link does not become congested for the controllable traffic.

14. The apparatus as described in claim 13, wherein the program code is further configured to:
determine whether the non-controllable traffic associated with the one or more virtual machines is within a configurable threshold of the link capacity; and
based on a determination that the non-controllable traffic associated with the one or more virtual machines is within the configurable threshold of the link capacity, raise an alert.

15. The apparatus as described in claim 14, wherein the program code is further configured, in response to the alert, and for each of the one or more virtual machines, to:
compute a fair share of bandwidth on the link for the virtual machine;
identify whether the virtual machine is egressing more than the fair share computed for the virtual machine on the link; and
apply a rate limit to the traffic being served over the link by the virtual machine when the virtual machine is identified as egressing more than its fair share for the link.

16. The apparatus as described in claim 15, wherein the rate limit is applied using an operating system traffic control subsystem.

17. A method for traffic management over a link associated with an overlay network, wherein at least a portion of a capacity of the link is anticipated to be required to handle traffic that is not directly controllable by a traffic manager associated with the network, comprising:
deploying a cloud compute control plane to a network host, the network host being one of a set of distributed hosts comprising a multi-tenant shared infrastructure;
instantiating a set of virtual machines on the network host;
monitoring the traffic being served over the link and associated with the set of virtual machines; and
in response to the monitoring, selectively throttling the traffic associated with the set of virtual machines on the link by adjusting how the portion of the link capacity is allocated to at least one or more of the virtual machines of the set.

18. The method as described in claim 17, wherein each of the virtual machines of the set is allocated a determined fair share for that virtual machine.
